(19) United States
(12) Patent Application Publication
(10) Pub. No.: US 2026/0087465 A1
(43) Pub. Date: Mar. 26, 2026

(54) RECEIPT SERVER, INFORMATION PROCESSING APPARATUS, METHOD OF CONTROLLING RECEIPT SERVER, AND METHOD OF CONTROLLING INFORMATION PROCESSING APPARATUS

(71) Applicant: Toshiba Tec Kabushiki Kaisha, Tokyo (JP)

(72) Inventors: Yasuhiro ARAI, Mishima Shizuoka (JP); Toru OGAWA, Izunokuni Shizuoka (JP)

(21) Appl. No.: 19/310,872

(22) Filed: Aug. 26, 2025

(30) Foreign Application Priority Data
Sep. 25, 2024 (JP) 2024-166616

(51) Int. Cl. G06Q 20/04

(52) U.S. Cl. CPC G06Q 20/047

(57) ABSTRACT

A graphical user interface (GUI) includes a user interface for managing delivery of sales promotional information with electronic receipts. The user interface includes a first section for specifying sales promotions, a second section for specifying details about the sales promotions, a third section for specifying target locations for the sales promotions, a fourth section for specifying companies whose sales promotions are to be excluded, and a fifth section for specifying a display channel for the sales promotions. A control device stores information about the sales promotions that were specified through the GUI, stores receipt data of a receipt related to a transaction of a commodity purchased by the customer, transmits in response to a request from an information processing apparatus of the customer, the receipt data and the sales promotions based on the information about the sales promotions that have been specified through the GUI to the information processing apparatus.

### CROSS-REFERENCE TO RELATED APPLICATION(S)

This application is based upon and claims the benefit of priority from Japanese Patent Application No. 2024-166616, filed on Sep. 25, 2024, the entire contents of which are incorporated herein by reference.

### FIELD

Embodiments described herein relate generally to a receipt server, an information processing apparatus, a method of controlling a receipt server, and a method of controlling an information processing apparatus.

### BACKGROUND

An electronic receipt service that provides a customer who bought a commodity at a retail store a computerized receipt for the transaction, is known. In the electronic receipt service, it is possible to acquire electronic receipt data from an electronic receipt server and browse the electronic receipt data with a mobile terminal such as a smartphone.

Currently, an electronic receipt app which operates on a mobile terminal for displaying the electronic receipt is capable of displaying promotion information or the like as sales promotion information of a commodity together with the electronic receipt. Meanwhile, a company which manages a store where the electronic receipt service is made available provides customers with an app of the company different from the electronic receipt app, and thus provides sales promotion information of its own products through the app of the company. When the company makes the electronic receipt service available, the company also makes the electronic receipt service available from the app of the company.

### BRIEF DESCRIPTION OF THE DRAWINGS

FIG. 1 is a block diagram showing a schematic configuration of an electronic receipt system, and circuit configurations of essential portions of an information processing apparatus and a receipt server included in the electronic receipt system according to an embodiment.

FIG. 2 is a diagram schematically showing a structure of a data record included in a receipt database.

FIG. 3 is a diagram schematically showing a structure of a data record included in a customer database.

FIG. 4 is a diagram schematically showing a structure of a data record included in a promotion database.

FIG. 5 is a flowchart illustrating promotion setup processing to be executed by a control device of a receipt server in accordance with a server app.

FIG. 6 is a diagram showing an example of a promotion setup screen.

FIG. 7 is a flowchart illustrating processing to be executed by the control device.

FIG. 8 is a flowchart illustrating processing to be executed by the control device.

FIG. 9 is a diagram showing an example of a receipt screen.

FIG. 10 is a diagram showing an example of a display screen of promotion information.

### DETAILED DESCRIPTION

Embodiments provide a receipt server, an information processing apparatus, a method of controlling a receipt server, and a method of controlling an information processing apparatus which enable control sales promotion information to be delivered in accordance with configurable settings.

In general, according to one embodiment, a receipt server includes a control device which executes a program for operating the receipt server. A communication interface communicates with external devices including an information processing apparatus of a customer. The control device executes the program to generate a graphical user interface (GUI) that includes a user interface for managing delivery of sales promotional information with electronic receipts. The user interface includes a first section for specifying sales promotions, a second section for specifying details about the sales promotions, a third section for specifying target locations for the sales promotions, a fourth section for specifying companies whose sales promotions are to be excluded, and a fifth section for specifying a display channel for the sales promotions. The control device stores information about the sales promotions that have been specified through the GUI, stores receipt data of a receipt related to a transaction of a commodity purchased by the customer, transmit in response to a request from an information processing apparatus of the customer, the receipt data and one or more of the sales promotions based on the information about the sales promotions that have been specified through the GUI to the information processing apparatus of the customer.

An embodiment will hereinafter be described with reference to the drawings.

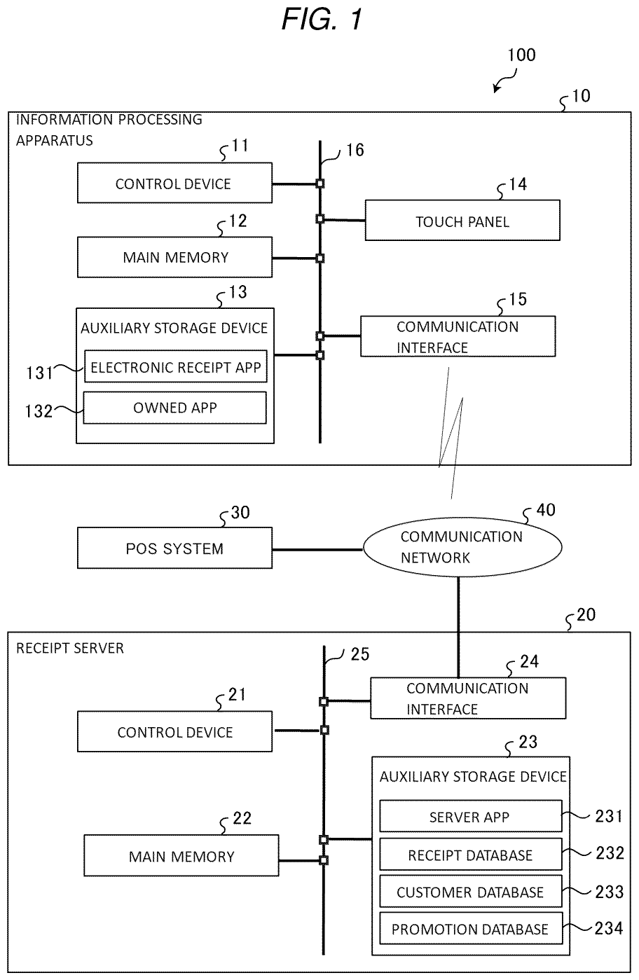

FIG. 1 is a block diagram showing a schematic configuration of an electronic receipt system 100 according to the present embodiment, and circuit configurations of essential portions of an information processing apparatus 10 and a receipt server 20 included in the electronic receipt system 100.

The electronic receipt system 100 includes the information processing apparatus 10, the receipt server 20, and a POS (Point Of Sales) system 30 communicating with each other via a communication network 40. As the communication network 40, the Internet, a virtual private network (VPN), a local area network (LAN), a public telecommunication network, a mobile communication network, and so on can be used alone or in any combination with each other. It should be noted that the electronic receipt system 100 typically includes a plurality of information processing apparatuses 10 and a plurality of POS systems 30, but FIG. 1 shows just one information processing apparatus 10 and just one POS system 30.

The information processing apparatus 10 performs display of a receipt screen for displaying content of a transaction based on the electronic receipt data acquired from the receipt server 20, and so on, in accordance with an operation by a user (e.g., a customer) of the electronic receipt service provided by the electronic receipt system 100. Further, the information processing apparatus 10 performs display of not only the receipt screen but also a sales promotion screen for displaying sales promotion information provided by the receipt server 20 and so on using the electronic receipt service. The sales promotion information includes promotion information related to a promotion to be performed by a company, coupon information related to a coupon which can be applied to a commodity sold by the company, and so on. A date related to the sales promotion may be included. When a plurality of information processing apparatuses 10 is included in the electronic receipt system 100, the plurality of information processing apparatuses 10 may be used by the same user, or may individually used by users different from each other. Alternatively, a plurality of users may share one information processing apparatus 10.

The receipt server 20 acquires, from the POS system 30, receipt data including information to be displayed on a receipt related to a transaction managed by the POS system 30, and then accumulates the receipt data. The receipt server 20 acquires the receipt data from the POS systems 30 of respective stores operated respectively by a plurality of companies which provide the electronic receipt service, and then accumulates the receipt data for each of the users who use the electronic receipt service. The receipt server 20 generates screen data of the receipt screen in accordance with a request from the information processing apparatus 10 by an operation of a user, and instructs the information processing apparatus 10 to display the receipt screen accompanied by a notice of the screen data.

The POS system 30 performs processing for registration of content of a transaction such as commodity sales, and so on in the store. When the customer who is a target of a transaction is a user of the electronic receipt service, the POS system 30 transmits the receipt data related to the transaction to the receipt server 20.

The information processing apparatus 10 is typically an information processing apparatus of a portable type such as a smartphone, a cellular phone, or a tablet terminal. The information processing apparatus 10 may be a stationary information processing apparatus such as a desktop personal computer.

The information processing apparatus 10 is provided with a control device 11, a main memory 12, an auxiliary storage device 13, a touch panel 14, a communication unit 15, a transmission path 16, and so on. The control device 11, the main memory 12, the auxiliary storage device 13, the touch panel 14, and the communication unit 15 are coupled to each other via the transmission path 16.

In the information processing apparatus 10, the control device 11, the main memory 12, and the auxiliary storage device 13 are coupled to each other with the transmission path 16, so that a computer which performs information processing for controlling the information processing apparatus 10 can be realized.

The control device 11 corresponds to a central portion of the computer described above. The control device 11 controls each unit so as to realize a variety of types of functions as the information processing apparatus 10 with an information processing program such as an operating system, middleware, and an application program.

The main memory 12 corresponds to a main memory portion of the computer described above. The main memory 12 includes a nonvolatile memory area and a volatile memory area. The main memory 12 stores the information processing program in the nonvolatile memory area. Further, the main memory 12 stores, in the nonvolatile or the volatile memory area, data which is necessary for the control device 11 to execute processing for controlling each unit in some cases. The main memory 12 uses the volatile memory area as a work area in which data is rewritten as appropriate by the control device 11.

The auxiliary storage device 13 corresponds to an auxiliary storage portion of the computer described above. The auxiliary storage device 13 is, for example, an EEPROM (electrically erasable programmable read-only memory). A well-known storage device such as an HDD (hard disc drive) or an SSD (solid state drive) is provided. The auxiliary storage device 13 saves data which is used by the control device 11 when performing a variety of types of processing, and data which is generated by the processing in the control device 11. The auxiliary storage device 13 stores the information processing program.

As one of the information processing programs stored in the auxiliary storage device 13, an application program (hereinafter referred to as an electronic receipt app) 131 for displaying receipt data for displaying the receipt screen based on the electronic receipt data acquired from the receipt server 20, and an company-owned application program company-owned app 132 individually provided by the company (hereinafter referred to as a company-company-owned app) are included.

The company-owned app 132 provides a function of delivering information related to stores operated by a company which provides the company-owned app 132 and commodities sold by the company, or a variety of services provided by the company, collecting information of the customers, and so on. Further, regarding the company-owned app 132, when the electronic receipt service is available in a transaction of the company which provides the company-owned app 132, there is provided a function of using the electronic receipt service through the company-owned app 132. For example, a use button for the electronic receipt service is provided in a menu screen displayed by the company-owned app 132. When the use button is selected, it is possible to start up, for example, a browser program, and receive the electronic receipt data through the browser to display the receipt screen.

The electronic receipt app 131 and the company-owned app 132 are downloaded via, for example, the Internet to be written to the auxiliary storage device 13 in accordance with an operation by the user on the information processing apparatus 10. That is, the installation of the receipt app 131 or the company-owned app 132 by the user of the information processing apparatus 10 may be performed in a state where the apps are not stored in the auxiliary storage device 13. However, the electronic receipt app 131 or the company-owned app 132 may be installed by the user of the information processing apparatus 10 in a state of being stored in the auxiliary device 13. The user of the information processing device 10 can download a plurality of company-owned app 132 respectively corresponding to a plurality of companies and store them in the auxiliary device 13. It is possible for the user of the information processing apparatus 10 to download a plurality of company-owned apps 132 corresponding respectively to a plurality of companies, and to store the plurality of company-owned apps 132 in the auxiliary storage device 13.

The touch panel 14 functions as an input device and a display device of the information processing apparatus 10.

The communication unit 15 is an interface of data communication via the communication network 40. As the communication unit 15, a well-known communication device for performing data communication via, for example, a mobile communication network or the Internet can be used.

The transmission path 16 includes an address bus, a data bus, control signal lines, and so on, and transmits data and control signals to be exchanged between the units coupled to each other.

The receipt server 20 is provided with a control device 21, a main memory 22, an auxiliary storage device 23, a communication unit 24, a transmission path 25, and so on. The control device 21, the main memory 22, the auxiliary storage device 23, and the communication unit 24 are coupled to each other with the transmission path 25. The transmission path 25 includes an address bus, a data bus, control signal lines, and so on, and transmits data and control signals to be exchanged between the units coupled to each other.

In the receipt server 20, the control device 21, the main memory 22, and the auxiliary storage device 23 are coupled to each other with the transmission path 25, so that a computer which performs information processing for controlling the receipt server 20 can be realized.

The control device 21 corresponds to a central control portion of the computer described above. The control device 21 controls each unit so as to realize a variety of types of functions as the receipt server 20 according to the information processing program.

The main memory 22 corresponds to a main memory portion of the computer described above. The main memory 22 includes a nonvolatile memory area and a volatile memory area. The main memory 22 stores the information processing program in the nonvolatile memory area. Further, the main memory 22 stores, in the nonvolatile or the volatile memory area, data which is necessary for the control device 21 to execute processing for controlling each unit in some cases. The main memory 22 uses the volatile memory area as a work area in which data is rewritten as appropriate by the control device 21.

The auxiliary storage device 23 corresponds to an auxiliary storage portion of the computer described above. The auxiliary storage device 23 is, for example, an EEPROM, an HDD, or an SSD. The auxiliary storage device 23 saves data which is used by the control device 21 when performing a variety of types of processing, and data which is generated by the processing in the control device 21. The auxiliary storage device 23 stores the information processing program in some cases. One of the information processing programs stored by the auxiliary storage device 23 is an application program (hereinafter referred to as a server app) 231 for the receipt server 20 to operate the electronic receipt service. A part of a storage area of the auxiliary storage device 23 is used as a receipt database 232, a customer database 233, and a promotion database 234. The details of the receipt database 232, the customer database 233, and the promotion database 234 will be described later.

The communication unit 24 is an interface of data communication via the communication network 40. As the communication unit 24, a well-known communication device for performing data communication via, for example, the Internet can be used.

The transmission path 25 includes an address bus, a data bus, control signal lines, and so on, and transmits data and control signals to be exchanged between the units coupled to each other.

In the receipt server 20, a general purpose computer apparatus, for example, can be used as basic hardware. In such a case, the server app 231 is not stored in the auxiliary storage device 23, and the server app 231 is retrieved from a removable recording medium such as a magnetic disc, a magnetooptical disc, an optical disc, or a semiconductor memory, or downloaded via a network. Further, in this case, the server app 231 is written to the auxiliary storage device 23 in accordance with an operation by an administrator of the receipt server 20, an installation operator of the receipt server 20, or the like.

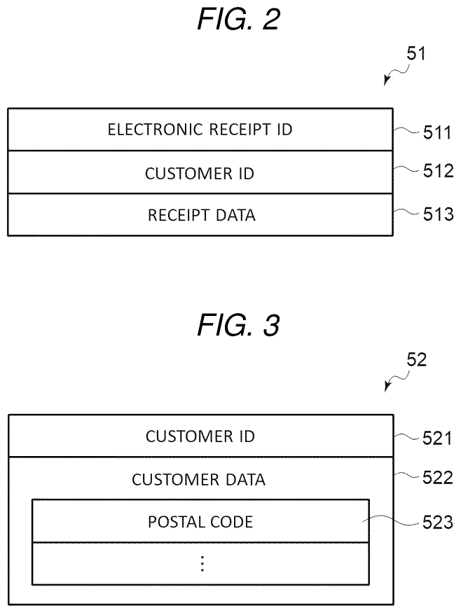

FIG. 2 is a diagram schematically showing a structure of a data record 51 included in the receipt database 232.

The receipt database 232 is an aggregate of the data records 51. One data record 51 is associated with the electronic receipt related to one transaction. In a field 511 of the data record 51, an electronic receipt ID as an identifier of the electronic receipt associated therewith is set. In a field 512, a user ID as an identifier of the user of the electronic receipt associated therewith is set. In a field 513, receipt data as main content of the electronic receipt associated therewith is set. It should be noted that a configuration in which the receipt data itself is prepared as an independent data file, and a file path of the receipt data is set in the field 513 may be adopted.

FIG. 3 is a diagram schematically showing a structure of a data record 52 included in the customer database 233.

The customer database 233 is an aggregate of the data records 52. One data record 52 is generated with respect to one user (an electronic receipt customer) who uses the electronic receipt service. In a field 521, a user ID which is issued for each user and is unique to each user is set. In a field 522, data related to the user is set. The data related to the user includes data such as telephone number (a cellular phone number), an e-mail address, a passcode, a postal code 523, male or female, and a date of birth. The telephone number (the cellular phone number), and the e-mail address and the passcode are used as login information which is input by the user when using the electronic receipt service. The postal code 523 is referred to as location information representing a location related to the user in order to determine (presume) a resident area of the user. It should be noted that it is possible to register, in the customer database 233, other information representing a location related to a user such as an address, a telephone number (with an area code) of a fixed telephone so as be available in addition to the postal code 523.

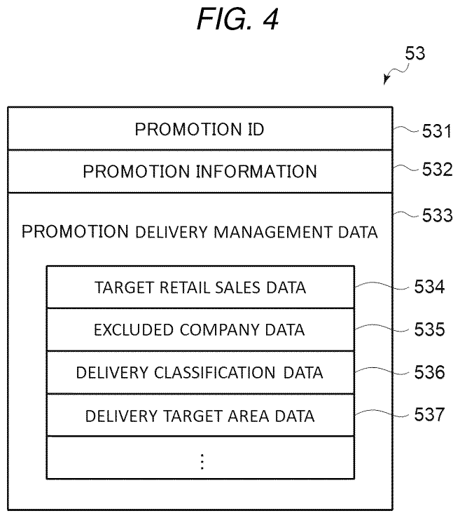

FIG. 4 is a diagram schematically showing a structure of a data record 53 included in the promotion database 234.

The promotion database 234 is an aggregate of the data records 53. One data record 53 is generated with respect to one promotion. In a field 531, a promotion ID which is issued for each promotion and is unique to each promotion is set. In a field 532, promotion information including a variety of types of data related to the promotion is set. The promotion information includes an image, a text, and so on to be displayed on a sales promotion screen of the information processing apparatus 10 which is the delivery destination as the content of the promotion displayed to the user. In a field 533, promotion delivery management data representing conditions for delivering the promotion information to the information processing apparatus 10 which is an output destination of the electronic receipt data is set. The promotion delivery management data includes, for example, target retail sales data 534 for a company (e.g., a retail sales company) which is a delivery target of the promotion information, excluded company data 535 representing a company to be excluded from the promotion information (e.g., another company which competes against a company that is providing the promotion information or the like), delivery classification data 536 representing a method of delivering the promotion information, and delivery target area data 537 representing an area (a regional division, a prefecture, and so on) which is a target location for the promotion information.

The information processing apparatus 10 which uses the electronic receipt service receives the electronic receipt data using the electronic receipt app 131 or the company-owned app 132 to thereby display the receipt screen. The login information that identifies the user who uses the electronic receipt service, is registered in advance at the time of login to the electronic receipt service or opening of the electronic receipt app or the company-owned app. Thus, in the receipt server 20, the user is identified by referring to the customer database 233, and the resident area of the user can be determined (presumed) based on the postal code 523. Further, when using the electronic receipt service from the information processing apparatus 10 through the company-owned app 132, the receipt server 20 can receive data with which a company providing the company-owned app 132 via a browser can be identified. In the receipt server 20, it is possible to control the delivery of the promotion information based on the promotion delivery management data 534 to 537. For example, the electronic receipt service (receipt data) is delivered to the information processing apparatus 10 in accordance with device-specific attributes, such as the geographic area associated with the user or the identity of the company associated with a company-owned application 13 installed on the device. The details of the promotion delivery management data 534 to 537 will be described later.

Then, an operation of the electronic receipt system 100 will be described. It should be noted that the content of a variety of types of processing described below is an example, a change in order of some processing, an omission of some processing, an addition of other processing, or the like can be made as appropriate.

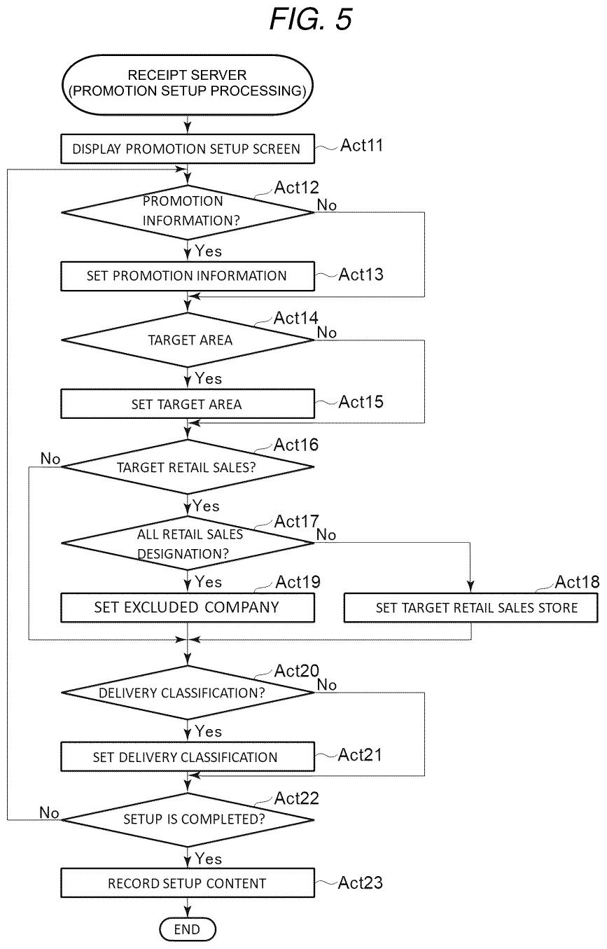

FIG. 5 is a flowchart illustrating promotion setup processing to be executed by the control device 21 of the receipt server 20 in accordance with the server app 231. The promotion setup processing is processing for setting the promotion information to be delivered in accordance with the information processing apparatus 10 which is an output destination of the electronic receipt data from the receipt server 20, and the promotion delivery management data for controlling the delivery of the promotion information.

For example, the receipt server 20 is accessed through the communication network 40 with the information processing apparatus (not shown) such as a personal computer, and execution of the promotion setup processing is requested. It should be noted that only the administrator of the receipt server 20 and so on are allowed to execute the promotion setup processing.

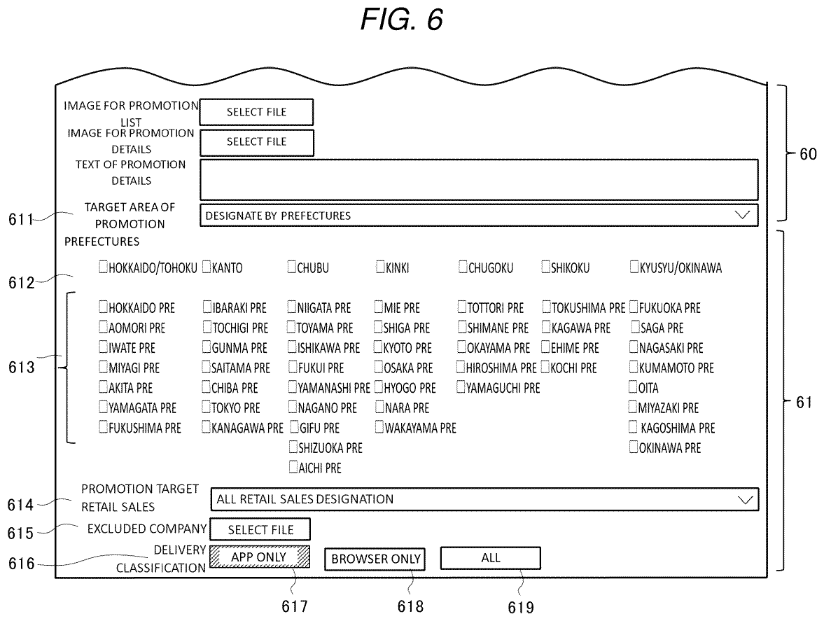

When there is an execution request for the promotion setup processing, the control device 21 makes the information processing apparatus display the promotion setup screen (ACT11). The control device 21 sets a new promotion ID 531 with respect to the registration of the new promotion information, and then starts registration processing using the promotion database 234. FIG. 6 is a diagram showing an example of the promotion setup screen. In the promotion setup screen, a promotion information setup area 60 for registering the promotion information, and a delivery management data setup area 61 for setting the promotion delivery management data are disposed. In the promotion information setup area 60, a plurality of setup sections for setting an image, a text, and so on to be displayed on the sales promotion screen of the information processing apparatus 10 which is the delivery destination as the content of the promotion displayed to the user are disposed.

Further, in the delivery management data setup area 61, for example, a promotion target area selection section 611, a regional division selection section 612, a prefecture selection section 613, a promotion target retail sales setup section 614, an excluded company selection section 615, and a delivery classification selection section 616 are disposed.

In the promotion target area selection section 611, for example, “designate by prefectures,” “without designation (whole of country),” and “designate by postal codes” can be selected. In the regional division selection section 612, for example, one regional division or a plurality of regional divisions can be selected at will. In the prefecture selection section 613, for example, one prefecture or a plurality of prefectures can be selected at will. In the promotion target retail sales setup section 614, for example, “designate all retail sales” and “select retail sales” can be selected. In the excluded company selection section 615, when the setting in the promotion target retail sales setup section 614 is “designate all retail sales” (default), companies to be excluded from the delivery target of the promotion information can be selected. Here, it is assumed that a plurality of company files in which specific companies or companies of each of specific groups are set is prepared in advance, and any of the company files may be selected. The delivery classification selection section 616 is for selecting the delivery a display channel for the electronic receipt service, which may be, for example, any one of “app only” 617 (representing use of the electronic receipt app 131 or company-owned app 132), “browser only” 618 (representing use of the browser), or “all”619 can be selected.

When there is an input operation to the setup section in the promotion information setup area 60 on the promotion setup screen (Yes in ACT12), the control device 21 sets the information input to the setup section into the setup section (ACT13).

Further, when there is an input operation of setting an area to the promotion target area election section 611, the regional division selection section 612, or the prefecture selection section 613 (Yes in ACT14), the control device 21 performs the setup (check display in a check box) in accordance with the input operation to each of the selection sections (ACT15). By setting the promotion target area, it is possible to set the conditions so as to deliver the promotion information only to, for example, a specific area where the company providing the promotion information opens stores. Further, when another company which competes against the company providing the promotion information opens stores in a specific area, it is also possible to set the conditions so that the promotion information is not delivered to the users of the electronic receipt service who reside in the area where the competitor company opens a lot of stores.

Further, when the setup to the promotion target retail sales setup section 614 is made (Yes in ACT16), and “designate all retail sales” is set (Yes in ACT17), the control device 21 makes it possible to set the excluded company selection section 615. When an setup operation to the excluded company selection section 615 is made, that is, when an operation of selecting any of the plurality of company files in which specific companies or companies of each of the specific groups are set is made, the control device 21 sets the file representing the excluded companies in the field 533. By setting the excluded company, it is possible to set the conditions so that the promotion information of another company which competes against the company providing the company-owned app 132 used in the information processing apparatus 10 is not delivered to the information processing apparatus 10. Further, when “select retail sales” is set in the promotion target retail sales setup section 614, “retail sales or store designation” is made possible instead of the setup of the excluded company selection section 615 to make it possible to select a store (or a store group) with a setup operation (ACT18).

Further, the control device 21 sets the state in which any one of “app only” 617, “browser only” 618, and “all” 619 is selected in accordance with (Yes in ACT20) the input operation to the delivery classification selection section 616. FIG. 6 shows the state in which “app only”617 is set.

When the setup operations to the setup sections of the promotion setup screen are terminated (Yes in ACT22), the control device 21 records the setup contents of the setup sections in the promotion database 234 in association with the promotion ID 531 (ACT23).

In this way, by setting the promotion delivery management data 534 to 537 to each of the plurality of pieces of promotion information provided from a plurality of different companies, it is possible to set the conditions on whether to deliver the promotion information to the information processing apparatus 10 which uses the electronic receipt service.

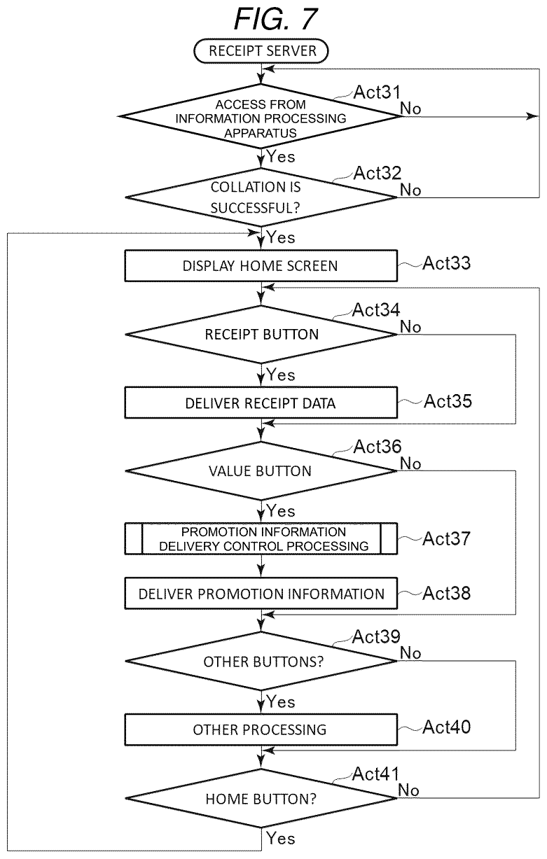

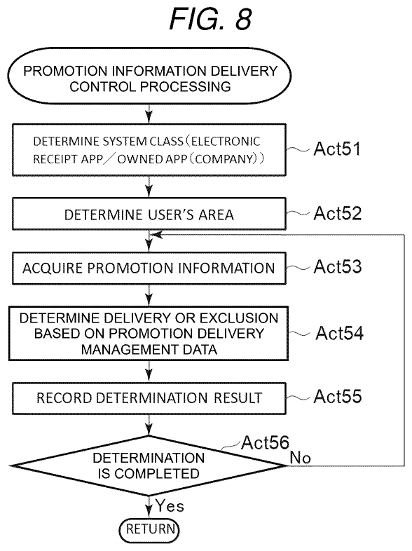

Then, processing of the receipt server 20 to the access from the information processing apparatus 10 will be described. FIG. 7 and FIG. 8 are flowcharts illustrating processing to be executed by the control device 21 of the receipt server 20.

When an access from the information processing apparatus 10 occurs (Yes in ACT31), the control device 21 of the receipt server 20 makes the information processing apparatus 10 display, for example, a login screen to ask for the input of the login information. It should be noted that it is assumed that when the login information input at the time of previous login is stored in the information processing apparatus 10, the login information is transmitted from the information processing apparatus 10 to the receipt server 20 at the time of the access.

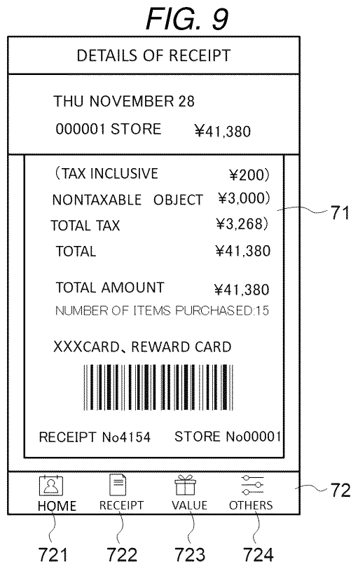

The control device 21 collates the customer database 233 based on the login information (e.g., the telephone number (the cellular phone number), the e-mail address and the passcode), and when that the electronic receipt customer logs in is confirmed (Yes in ACT32), the control device 21 makes the information processing apparatus 10 display the home screen for using the electronic receipt service (ACT33). On the home screen, for example, a two-dimensional code representing the electronic receipt ID unique to the electronic receipt customer is displayed, and menu buttons 72 (see FIG. 9) are disposed. As the menu buttons 72, for example, a home button 721 for instructing to display the home screen, a receipt button 722 for instructing to display the receipt data, a value button 723 for instructing to display the sales promotion information including the promotion information, and others button 724 for making other processing requests are disposed.

When the display of the electronic receipt is instructed by a selection operation of the receipt button 722 disposed as the menu button 72, the control device 21 outputs the receipt data which is recorded on the receipt database 232 in association with the electronic receipt customer to the information processing apparatus 10 (ACT35). The information processing apparatus 10 displays the receipt screen based on the receipt data from the receipt server 20. FIG. 9 is a diagram showing an example of the receipt screen. In an example shown in FIG. 9, an example in which a receipt image 71 as the same image as, for example, a paper receipt is displayed is shown. It should be noted that in the receipt screen, it is possible to display a list of the receipt data in the present month, a total amount of all the receipt data, and so on.

Further, when a selection operation of the others button 724 is made (Yes in ACT39), the control device 21 executes the other processes. When a selection operation of the home button 721 is made (Yes in ACT41), the control device 21 displays the home screen (ACT33).

Meanwhile, when the display of the sales promotion information is instructed (Yes in ACT36) by a selection operation of the value button 723, the control device 21 executes promotion information delivery control process for controlling the promotion information (the sales promotion information) to be delivered to the information processing apparatus 10 (ACT37).

The control device 21 determines whether the access from the information processing apparatus 10 is made by the electronic receipt app 131 or made by the company-owned app 132 (the system class) (ACT51 in FIG. 8). When the access through the company-owned app 132 is made, a company which provides the company-owned app 132 is determined. Further, by referring to the customer database 233, the residence area of the electronic receipt customer is determined (presumed) based on the postal code 523 corresponding to the login information of the electronic receipt customer (ACT52).

The control device 21 searches the promotion delivery management data 534 to 537 of the plurality of pieces of receipt information registered in the receipt database 232 based on the system class (the companies which provides the company-owned app 132) of the information processing apparatus 10 and the residence area of the electronic receipt customer to select the promotion information (the promotion ID) corresponding to the delivery target.

The control device 21 acquires the plurality of pieces of promotion information (promotion delivery management data) registered in the promotion database 234 (ACT53), then determines whether to deliver the promotion information or to exclude the promotion information based on the promotion delivery management data (ACT54), and then records the determination result (ACT55).

For example, when the access from the information processing apparatus 10 is made through the company-owned app 132 (the browser), the delivery classification data 536 represents “browser only,” and when a company (a second company) which provides the company-owned app 132 and a company (a first company) represented by the excluded company data 535 are the same, the promotion information in which the corresponding promotion delivery management data is set is excluded from the delivery target. That is, the promotion information of another company competing against the company which provides the company-owned app 132 is prevented from being delivered. Thus, the promotion information of another competing company becomes not to be displayed in the information processing apparatus 10 which executes the company-owned app 132, and thus, a disadvantage for the company which provides the company-owned app 132 is prevented from occurring.

Further, when the delivery target area data 537 does not correspond to the resident area of the electronic receipt customer, the promotion information in which the corresponding promotion delivery management data is set is excluded from the delivery target.

The control device 21 determines the delivery or the exclusion on each promotion information registered in the promotion database 234 (ACT53 to ACT55).

When the control device 21 completes the determination on each promotion information registered in the promotion database 234 (Yes in ACT56), the control device 21 delivers the promotion information recorded as the delivery target to the information processing apparatus 10 (ACT38 in FIG. 7).

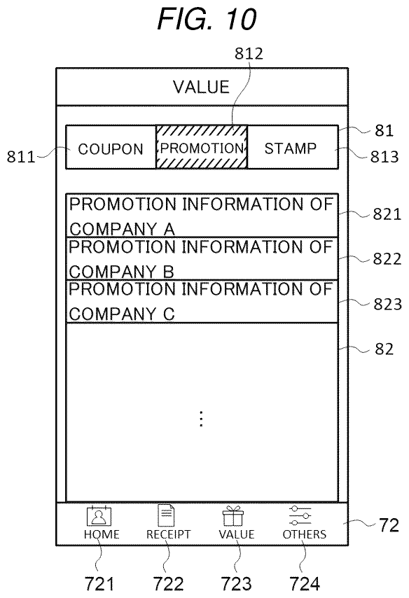

The information processing apparatus 10 displays the display screen of the promotion information based on the promotion information delivered from the receipt server 20. FIG. 10 is a diagram showing an example of the display screen of the promotion information. In the display screen of the promotion information shown in FIG. 10, menu buttons 81 for selecting the sales promotion information are disposed, and it is possible to select a coupon 811, a promotion 812, and a stamp 813. Here, a state in which the promotion 812 is selected is shown, and a plurality of pieces of promotion information is displayed as a list in the display area 82.

For example, FIG. 10 shows that promotion information of a company C is excluded from the delivery target while the promotion information of each of a company A, a company B, a company C, and a company D is registered in the promotion database 234. That is, since the company which provides the company-owned app 132 executed in the information processing apparatus 10 is set in the excluded company data 535 of the promotion information of the company C, the promotion information of the competing company C is not displayed.

In this way, in the receipt server 20 in the present embodiment, by setting the promotion delivery management data to each promotion information registered in the promotion database 234, it becomes possible to control the delivery and the exclusion of the promotion information in accordance with the information processing apparatus 10 which is the provision destination of the electronic receipt service.

Therefore, it is possible for the company to make it possible to provide the electronic receipt service together with the sales promotion information of the own commodities with the app dedicated to the company, and to prevent the sales promotion information of a competing company which is disadvantageous for the own company from being delivered through the electronic receipt service.

It should be noted that in the above description, the delivery or the exclusion of the promotion information is determined in the receipt server 20 with reference to the promotion delivery management data corresponding to the promotion information registered in the promotion database 234, but it is possible to determine, in the information processing apparatus 10, whether to display the promotion information delivered from the receipt server 20 on the display screen. For example, the receipt server 20 transmits, to the information processing apparatus 10, the data records 53 corresponding to a plurality of pieces of promotion information registered in the promotion database 234. In the information processing apparatus 10, whether to display the promotion information for each promotion information is determined in substantially the same manner as the promotion information delivery control processing in the receipt server 20 described above based on the data related to the company which provides the company-owned app 132 executed in the own apparatus, and the data related to the electronic receipt customer registered in the customer database 233, and the promotion information which is determined to be displayed is displayed as a list.

Thus, it is possible to prevent the promotion information of the company competing against the company which provides the company-owned app 132 executed in the information processing apparatus 10 from being displayed in substantially the same manner as described above.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A receipt server comprising:
a control device configured to execute a program for operating the receipt server; and
a communication interface configured to communicate with external devices including an information processing apparatus of a customer;
wherein the control device executes the program to:
generate a graphical user interface (GUI) that includes a user interface for managing delivery of sales promotional information with electronic receipts, wherein the user interface comprises:
a first section for specifying sales promotions;
a second section for specifying details about the sales promotions;
a third section for specifying target locations for the sales promotions;
a fourth section for specifying companies whose sales promotions are to be excluded; and
a fifth section for specifying a display channel for the sales promotions;
store information about the sales promotions that have been specified through the GUI;
store receipt data of a receipt related to a transaction of a commodity purchased by the customer; and
transmit, in response to a request from an information processing apparatus of the customer, the receipt data and one or more of the sales promotions based on the information about the sales promotions that have been specified through the GUI to the information processing apparatus of the customer.

2. The receipt server according to claim 1, wherein
the external devices include a POS system that processed the transaction of the commodity purchased by the customer.

3. The receipt server according to claim 1, further comprising:
an auxiliary storage device in which a receipt database and a customer database are stored, wherein the receipt database associates with each receipt tracked using the receipt database, an electronic receipt ID, a customer ID of a customer whose transaction is recorded on the receipt, and receipt data associated with the receipt, and the customer database associates with each customer tracked using the customer database, the customer ID and location information of the customer.

4. The receipt server according to claim 1, wherein the auxiliary storage device further includes a promotion database, and the promotion database associates with each sales promotion tracked using the promotion database, a unique promotion ID issued for each sales promotion, data related to the sales promotion, and delivery management data indicating conditions for delivering the sales promotion.

5. The receipt server according to claim 4, wherein the delivery management data includes one of a plurality of company files in which a specific company or a company for each specific group is identified, and the sales promotion of the specific company or the company for each specific group identified in the company files is not to be delivered.

6. The receipt server according to claim 4, wherein the delivery management data specifies a delivery location that is compared to a customer location, which is determined from a customer database that specifies a postal code of the customer, to determine whether or not to deliver the sales promotion to the customer.

7. The receipt server according to claim 4, wherein the sales promotion is delivered according to the display channel specified in the GUI.

8. The receipt server according to claim 7, wherein the display channel is browser-only, app-only, or both the browser and the app.

9. A method of delivering an electronic receipt that contains sales promotions from a receipt server to an information processing apparatus of a customer, the method comprising:
generating a graphical user interface (GUI) that includes a user interface for managing delivery of sales promotional information with electronic receipts, wherein the user interface comprises:
a first section for specifying sales promotions;
a second section for specifying details about the sales promotions;
a third section for specifying target locations for the sales promotions;
a fourth section for specifying companies whose sales promotions are to be excluded; and
a fifth section for specifying a display channel for the sales promotions;
storing information about the sales promotions that have been specified through the GUI;
storing receipt data of a receipt related to a transaction of a commodity purchased by the customer; and
transmitting, in response to a request from an information processing apparatus of the customer, the receipt data and one or more of the sales promotions based on the information about the sales promotions that have been specified through the GUI to the information processing apparatus of the customer.

10. The method according to claim 9, wherein the external devices include a POS system that processed the transaction of the commodity purchased by the customer.

11. The method according to claim 9, further comprising:
an auxiliary storage device in which a receipt database and a customer database are stored, wherein the receipt database associates with each receipt tracked using the receipt database, an electronic receipt ID, a customer ID of a customer whose transaction is recorded on the receipt, and receipt data associated with the receipt, and the customer database associates with each customer tracked using the customer database, the customer ID and location information of the customer.

12. The method according to claim 9, further comprising:
the auxiliary storage device further includes a promotion database, and the promotion database associates with each sales promotion tracked using the promotion database, a unique promotion ID issued for each sales promotion, data related to the sales promotion, and delivery management data indicating conditions for delivering the sales promotion.

13. The method according to claim 12, wherein the delivery management data includes one of a plurality of company files in which a specific company or a company for each specific group is identified, and the sales promotion of the specific company or the company for each specific group identified in the company files is not to be delivered.

14. The method according to claim 12, wherein
the delivery management data specifies a delivery location that is compared to a customer location, which is determined from a customer database that specifies a postal code of the customer, to determine whether or not to deliver the sales promotion to the customer.

15. The method according to claim 12, wherein the sales promotion is delivered according to the display channel specified in the GUI.

16. The method according to claim 12, wherein the display channel is browser-only, app-only, or both the browser and the app.
